(19) United States
(12) Patent Application Publication
(10) Pub. No.: US 2014/0181293 A1
(43) Pub. Date: Jun. 26, 2014

(54) METHODS AND APPARATUS FOR DETERMINING A MAXIMUM AMOUNT OF UNACCOUNTED-FOR DATA TO BE TRANSMITTED BY A DEVICE

(71) Applicants: Gautam Dilip Bhanage, Sunnyvale, CA (US); Abhijeet Bhorkar, Milpitas, CA (US); Sathish Damodaran, San Jose, CA (US)

(72) Inventors: Gautam Dilip Bhanage, Sunnyvale, CA (US); Abhijeet Bhorkar, Milpitas, CA (US); Sathish Damodaran, San Jose, CA (US)

(21) Appl. No.: 13/725,544

(22) Filed: Dec. 21, 2012

(51) Int. Cl. H04L 29/08

(52) U.S. Cl. CPC H04L 29/08099
USPC 709/224

(57) ABSTRACT

A method includes determining a maximum amount of unaccounted-for data to be transmitted by a particular client device associated with an access point. The maximum amount of unaccounted-for data may be based on characteristics associated with data received at an access point from one or more client devices. The maximum amount of unaccounted-for data may be based on a total number of client devices associated with an access point. The maximum amount of unaccounted-for data may be based on resources available at the access point.

### TECHNICAL FIELD

The present disclosure relates to configuring access points. In particular, the present disclosure relates to determining a maximum amount of unaccounted-for data to be transmitted by one or more client devices associated with the access point.

### BACKGROUND

Over the last decade, there has been a substantial increase in the use and deployment of wireless network devices, from dual-mode smartphones to tablets capable of operating in accordance with a particular Institute of Electrical and Electronics Engineers (IEEE) standard. With “wireless” becoming the de-facto medium for connectivity among users, it has become increasingly important for access points to maintain high throughput and avoid situations where airtime consumed at that access point is dominated by low-rate transmissions and retries caused by poor connectivity with one or more wireless client devices.

Currently, for IEEE 802.11e compliant wireless client devices, a transmission burst is limited by the transmission opportunity (TxOp). This approach may also control aggregation of resources by particular wireless client devices. This TxOp value can be set differently for each class of traffic (e.g., voice data, video data, best effort data and background data).

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one. In the drawings:

FIG. 1 shows a block diagram example of a system in accordance with one or more embodiments;

FIG. 2 shows a block diagram example of an access point in accordance with one or more embodiments;

FIG. 3 shows a messaging diagram demonstrating frame aggregation in accordance with one or more embodiments;

FIG. 4 shows a method for intelligently and dynamically determining the maximum amount of unaccounted-for data to be transmitted by client devices according to one embodiment.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

Herein, certain terminology is used to describe features for embodiments of the disclosure. For example, the term “digital device” generally refers to any hardware device that includes processing circuitry running at least one process adapted to control the flow of traffic into the device. Examples of digital devices include a computer, a tablet, a laptop, a desktop, a netbook, a server, a web server, authentication server, an authentication-authorization-accounting (AAA) server, a Domain Name System (DNS) server, a Dynamic Host Configuration Protocol (DHCP) server, an Internet Protocol (IP) server, a Virtual Private Network (VPN) server, a network policy server, a mainframe, a television, a content receiver, a set-top box, a video gaming console, a television peripheral, a printer, a mobile handset, a smartphone, a personal digital assistant “PDA”, a wireless receiver and/or transmitter, an access point, a base station, a communication management device, a router, a switch, and/or a controller.

One type of digital device, referred to as an “access point,” is a combination of hardware, software, and/or firmware that is configured to control the amount of airtime allocated between digital devices associated with the access point. According to one embodiment, the access point comprises a plurality of logic units that are adapted to manage wireless traffic based on a number of different parameters, including (1) characteristics of data received by access point 20, (2) a total number of client devices 30 associated with access point 20, and/or (3) characteristics of one or more resources available at access point 20 to one or more client devices 30 associated with the access point 20.

It is contemplated that a digital device may include hardware logic such as one or more of the following: (i) processing circuitry; (ii) one or more communication interfaces such as a radio (e.g., component that handles the wireless data transmission/reception) and/or a physical connector to support wired connectivity; and/or (iii) a non-transitory computer-readable storage medium (e.g., a programmable circuit; a semiconductor memory such as a volatile memory such as random access memory “RAM,” or non-volatile memory such as read-only memory, power-backed RAM, flash memory, phase-change memory or the like; a hard disk drive; an optical disc drive; etc.) or any connector for receiving a portable memory device such as a Universal Serial Bus “USB” flash drive, portable hard disk drive, or the like.

Herein, the terms “logic” (or “logic unit”) are generally defined as hardware and/or software. For example, as hardware, logic may include a processor (e.g., a microcontroller, a microprocessor, a CPU core, a programmable gate array, an application specific integrated circuit, etc.), semiconductor memory, combinatorial logic, or the like. As software, logic may be one or more software modules, such as executable code in the form of an executable application, an application programming interface (API), a subroutine, a function, a procedure, an object method/implementation, an applet, a servlet, a routine, source code, object code, a shared library/dynamic load library, or one or more instructions. These software modules may be stored in any type of a suitable non-transitory storage medium, or transitory computer-readable transmission medium (e.g., electrical, optical, acoustical or other form of propagated signals such as carrier waves, infrared signals, or digital signals).

Herein, the term “frame” is a grouping of data having a prescribed format and structure. A frame is the unit of transmission in a link layer protocol, and consists of a link-layer header followed by a packet. For example, a frame may be a data packet on Layer 2 of the OSI model, including Ethernet frames (maximum 1500 byte plus overhead), PPP frames, IEEE 802.11 frames (i.e., WiFi frames), and V.42 modem frames. Although the description below discusses uplink transmission in terms of frames, in other embodiments alternate segments of data may be similarly used.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

General Overview

In one or more embodiments, parameter values for a particular client device associated with an access point are determined based on one or more of (1) characteristics of data received by the access point, (2) a total number of client devices associated with the access point, and/or (3) characteristics of one or more resources available at the access point to one or more client devices associated with the access point. In one embodiment the access point determines a maximum amount of unaccounted-for data to be transmitted by the particular client device to the access point for a particular traffic class type without requiring an acknowledgement from the access point. In one embodiment, the maximum amount of unaccounted-for data comprises a maximum number of unaccounted-for frames a client device is permitted to send to the access point without relinquishing control of a radio, VAP, channel, or medium during a particular time period. Relinquishing control of a radio, VAP, channel, or medium may be defined as a node stopping transmission to allow other nodes (e.g., the access point and other client devices) to sense and transmit on the shared radio, VAP, channel, or medium. By calculating the maximum amount of unaccounted-for data based at least on one or more of these three factors, client devices are forced to adhere to airtime fairness quotas without requiring modifications to the client devices.

Architectural Overview

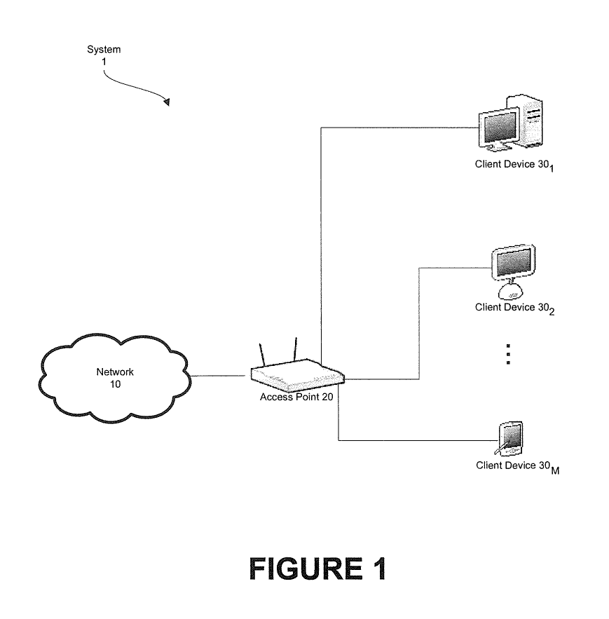

FIG. 1 shows a block diagram example of a system in accordance with one or more embodiments. System 1, as illustrated in FIG. 1, is a digital system that includes a network 10 (for example, a Local Area Network, a Wide Area Network, the Internet, an intranet, etc.) that comprises a plurality of digital devices such as an access point 20 and one or more client devices 30₁-30_{M} (M≧1). The client devices 30 may include any set of devices that communicate wirelessly with the access point 20 within system 1. In one or more embodiments, system 1 may include more or less devices, than the devices illustrated in FIG. 1, which may be connected to other devices within system 1 via wired and/or wireless mediums. In an example, system 1 may include a controller which is configured to communicate with one or more access points (for example, access point 20) within system 1. The controller may link access point 20 to network 10.

Access point 20 may be any device that can provide access to one or more network resources. For example access point 20 may be a router or any device that may be configured as a hotspot (e.g., a cell phone, a tablet, a laptop, etc.). Access point 20 is communicatively coupled to network 10 via a transmission medium to send and receive data. The data may include, for example, video data and/or voice data. The transmission medium may be a wired or a wireless connection. Access point 20 corresponds to a network device such as a wired access port, a wireless access port, a switch, a router, or any combination thereof. Access point 20 communicatively couples client devices 30 to network 10 or other client devices 30 by forwarding data to or from client devices 30. Although described in relation to an access point, system 1 may similarly apply the methods and techniques described herein with other digital devices capable of managing and/or receiving uplink data content.

In an embodiment, client devices 30 are digital devices that include a hardware processor, memory hierarchy, and input/output (I/O) interfaces including a wireless interface such as an IEEE 802.11 wireless interface. The wireless interface may be used to communicate with access point 20. Client devices 30 may be wireless electronic devices, capable of receiving video or other data streams, such as personal computers, laptop computers, netbook computers, wireless music players, portable telephone communication devices, smart phones, tablets, and digital televisions.

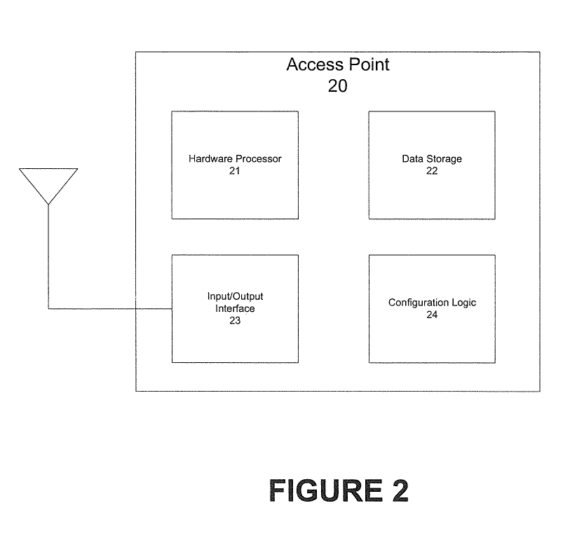

FIG. 2 shows a block diagram example of access point 20 in accordance with one or more embodiments. Access point 20 is a combination of hardware, software, and/or firmware that is configured to control the amount of airtime allocated between digital devices (e.g., client devices 30) associated with access point 20. According to one embodiment, access point 20 comprises a plurality of logic units that are adapted to manage wireless traffic based on a number of different parameters, including (1) characteristics of data received by access point 20, (2) a total number of client devices 30 associated with access point 20, and/or (3) characteristics of one or more resources available at access point 20 to one or more client devices 30 associated with the access point 20. In one embodiment as shown in FIG. 2, access point 20 is a network device that comprises one or more of: a hardware processor 21, data storage 22, an I/O interface 23, and device configuration logic 24. Other access points within system 1 may be configured similarly or differently than access point 20.

Data storage 22 of access point 20 may include a fast read-write memory for storing programs and data during access point 20's operations and a hierarchy of persistent memory, such as Read Only Memory (ROM), Erasable Programmable Read Only Memory (EPROM) and/or Flash memory for example, for storing instructions and data needed for the startup and/or operations of access point 20. Data storage 22 stores data that is to be transmitted from access point 20 or data that is received by access point 20. In an embodiment, data storage 22 is a distributed set of data storage components.

In an embodiment, I/O interface 23 corresponds to one or more components used for communicating with other devices (e.g., client devices 30) via wired or wireless signals. I/O interface 23 may include a wired network interface such as an IEEE 802.3 Ethernet interface and/or a wireless interface such as an IEEE 802.11 WiFi interface.

Hardware processor 21 is coupled to data storage 22 and I/O interface 23. Hardware processor 21 may be any processing device including, but not limited to a MIPS/ARM-class processor, a microprocessor, a digital signal processor, an application specific integrated circuit, a microcontroller, a state machine, or any type of programmable logic array.

In an embodiment, device configuration logic 24 includes one or more functional units implemented using firmware, hardware, software, or a combination thereof for configuring parameters associated with access point 20 and client devices 30. Although, device configuration logic 24 is shown as implemented on access point 20, one or more physical or functional components of device configuration logic 24 may be implemented on separate devices.

In one embodiment, access point 20 may be logically separated into one or more virtual access points (VAPs). In one embodiment, access point 20 may be separated into one or more radios with each radio additionally logically separated into one or more VAPs. The VAPs may each be allocated maximum allowable airtime quotas, which are used to promote airtime fairness. For example, access point 20 may be designated two VAPs: VAP₁ and VAP₂. VAP₁ may have a maximum allowable airtime quota of 40% of the total airtime capacity of access point 20 per radio while VAP₂ may have a maximum allowable airtime quota of 60% of the total airtime capacity of access point 20 per radio. In one embodiment, the percentage of airtime for a VAP is per multiple radios on access point 20 and/or across radios on multiple access points. The maximum allowable airtime quota per VAP may be further allocated by client device 30 and OBSS in addition to VAP and radio quotas. For example, each of client devices 30₁-30_{M} may have separate and unequal maximum allowable airtimes on VAP₁. In some embodiments, the quotas may be enforced for one VAP (e.g., VAP₁) while ignored for another VAP (e.g., VAP₂).

In one embodiment, the maximum allowable airtime quotas may be additionally sub-divided by traffic identifier (TID) or traffic class or access category (AC) type for each client device 30 and VAP. The TIDs or ACs may include voice data, video data, best effort (BE) data, and/or background (BK) data. For example, VAP₁ may include maximum allowable airtime quotas of 40%, 30%, 20%, and 10% for voice data, video data, BE data, and BK data, respectively, for each client device 30. In one embodiment, TID quotas may be applied upon initiation of Wireless Multimedia Extensions (WME) and/or Wi-Fi Multimedia (WMM).

Each of the airtime quotas described above may be preset by an administrator of system 1 and/or network 10. The quotas define airtime fairness (ATF) quotas, which seek to ensure fair use of access point 20's airtime.

Client Device and Access Point Uplink Message Transmissions

Client devices 30 may transmit/upload one or more messages (e.g. frames) containing data payloads to access point 20. For example, client device 30₁ may transmit a sequence of frames containing data corresponding to a streaming video to access point 20. In wireless systems, such as those described in the IEEE 802.11 standard, each frame transmission may contain a significant amount of overhead, including radio level headers, Media Access Control (MAC) frame fields, interframe spacing, acknowledgment of transmitted frames, and MAC frame retries. At the highest data rates, this overhead can consume more bandwidth than the data payload. Additionally, uplink transmissions may be further hampered by low speed client devices 30 using a disproportionate amount of airtime with respect to their throughput speed. This lack of airtime fairness may potentially result in uplink bottlenecks that affect higher speed client devices 30.

To abate these inefficiencies and/or unfairness in airtime consumed by client devices 30 and/or VAPs, wireless protocols are provided that allow for multiple frames to be transmitted in a single set of transmissions before an acknowledgment is required from a receiving node (e.g., access point 20). For example, the IEEE 802.11n standard defines two types of frame aggregation: MAC Service Data Unit (MSDU) aggregation and MAC Protocol Data Unit (MPDU) aggregation. Both aggregation types group several data frames into one large frame and require only a single acknowledgement from an access point or other receiving device. Because management information needs to be specified only once per frame, the ratio of payload data to the total volume of data is higher, allowing higher throughput.

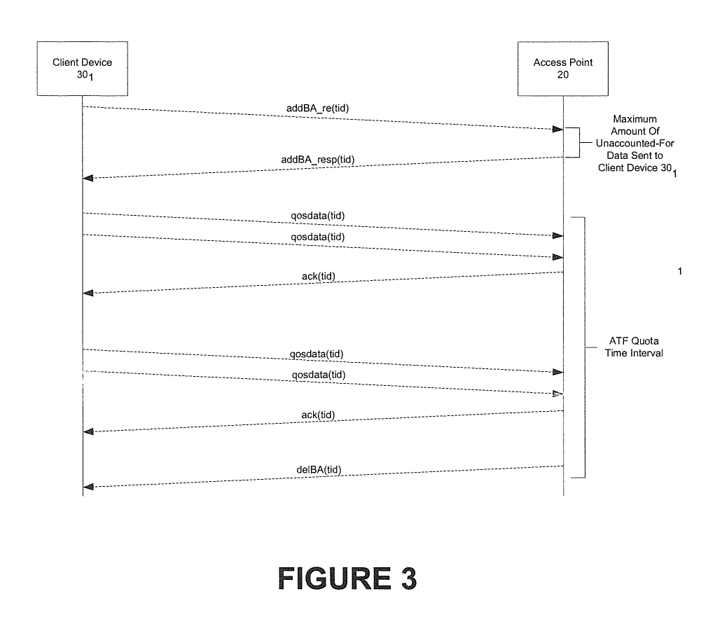

FIG. 3 shows a messaging diagram demonstrating frame aggregation. The transmission is shown between client device 30₁ and access point 20; however, a similar set of transmission may be performed between any of the nodes in FIG. 1. This messaging scheme may comply with one or more standards or protocols.

The communication session begins with client device 30₁ using a addba_req(tid) command to request a maximum amount of unaccounted-for data to be transmitted by client device 30₁ to access point 20 for a particular TID. The maximum amount unaccounted-for data comprises (a) data transmitted by client device 30₁ to access point 20 for which client device 30₁ does not receive an acknowledgement from access point 20 and (b) data transmitted by client device 30₁ to access point 20 that has not been determined by client device 30₁ to be dropped data. In one embodiment, the maximum amount unaccounted-for data may be controlled by block acknowledgment window size. In another embodiment, the maximum amount of unaccounted-for data comprises a maximum number of unaccounted-for frames client device 30₁ is permitted to send to access point 20 without relinquishing control of a radio, VAP, or medium during a particular time period. Relinquishing control of a radio or a VAP may be defined as a node stopping transmission to allow other nodes (e.g., access point 20 and client devices 30) to sense and transmit on the shared medium (wireless or wired). In still another embodiment, the maximum amount of unaccounted-for data comprises a maximum number of unaccounted-for frames that can be sent by client device 30₁ to devices within the same IP subnet (e.g., client devices 30₂-30_{M} and access point 20). The maximum amount of unaccounted-for data may be denoted as an MPDU or MSDU size at the MAC layer or a block acknowledgement window size.

In response to the request from client device 30₁, access point 20 calculates and transmits a maximum amount of unaccounted-for data to client device 30₁ by using an addba_resp(tid) command. During each transmission opportunity (TxOp) time interval, client device 30₁ transmits a set of frames (e.g., qosdata(tid)) and corresponding acknowledgment (e.g., ack(tid)) after the maximum amount of unaccounted-for data has been transmitted to access point 20. The communication between client device 30₁ and access point 20 may be terminated with the delBA(tid) command such that a new maximum amount of unaccounted-for data must be requested and received from access point 20. If client device 30₁ does not negotiate a new maximum amount of unaccounted-for data value (e.g., a new window size) after receiving a delBA(tid), in one embodiment, access point 20 could send a de-authorization command (e.g., deauth command) to client device 30₁ to force client device 30₁ to disconnect and re-connect with access point 20. This may result in client device 30₁ trying to re-negotiate the maximum amount of unaccounted-for data value. Although described in relation to access point 20, in one embodiment a controller or any other device connected to access point 20 may manage/calculate maximum amount of unaccounted-for data for one or more client devices 30.

With larger unchecked limits being allowed for the maximum amount of unaccounted-for data, it will be easier for a single bad client device 30 (e.g., a client device 30 with a slower transmission rate, a lower signal strength, and/or farther away from access point 20 in relation to other client devices 30) to bring down the capacity of an access point and all the Overlapping Basic Service Sets (OBSSs) that are operating on the same radio and/or VAP. To correct for this potential vulnerability, access point 20 aggressively and intelligently limits the maximum amount of unaccounted-for data for uplink traffic for the best performance and fairness of use of access point 20. By intelligently determining maximum amount of unaccounted-for data for uplink traffic produced by client devices, access point 20 may enforce fairness quotas without modification of client devices 30. In one embodiment, this aggressive maximum amount of unaccounted-for data control may be solely performed for bad client devices 30 without direct ATF enforcement. For example, upon determining that a client device 30 is a bad client device 30, the maximum amount of unaccounted-for data for this client device 30 would be reduced/limited.

Parameters Associated with Communication Between Client Devices and Access Points

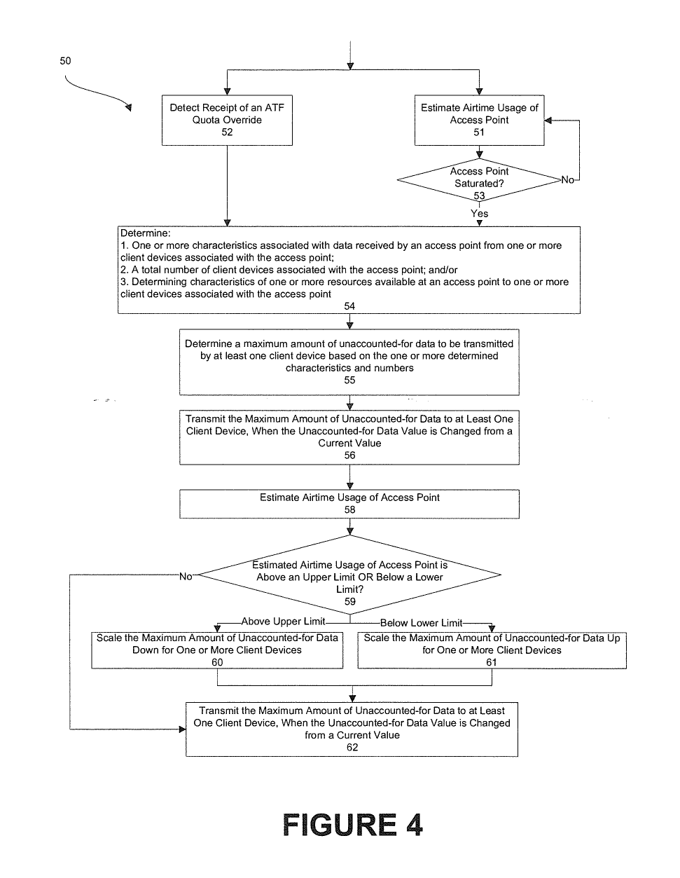

FIG. 4 shows an example method, method 50 for intelligently and dynamically determining the maximum amount of unaccounted-for data for client devices 30 according to one embodiment. Method 50 is performed by one or more components of access point 20. For example, method 50 may be performed by hardware processor 21 and configuration logic 24 based on inputs received from data storage 22 and input/output interface 23. In different embodiments, operations described in method 50 may be skipped or rearranged, and operations not described may be added. Accordingly, the specific sequence or combination of operations described herein should not be construed as limiting the scope of any of the embodiments.

Method 50 begins at either operation 51 or operation 52. At operation 51 airtime usage for access point 20 is estimated by access point 20. Estimated airtime usage defines the percentage/fraction of time the medium is busy with transmissions, retires, or reservations for frame transmission and interframe spaces. In one embodiment, the estimated airtime usage is calculated by measuring the total airtime usage across all VAPs for access point 20. For example, for access point 20 with VAP₁ and VAP₂, the estimated airtime usage is the sum of the individual airtime usages of VAP₁ and VAP₂. In one embodiment, the estimated airtime usage for access point 20 is calculated over a discrete time period to determine an average estimated airtime for access point 20 over bound time period. In some embodiments, estimated airtime usage may be based purely on calculations and/or measurements.

Following the calculation of the estimated airtime usage, operation 53 determines whether access point 20 in saturated. Saturation is defined as access point 20 being near or at full data transmission and reception processing capacity. Saturation may occur if one or more of client devices 30 make transmissions and retires that exceed ATF quotas. In one embodiment, access point saturation is determined by comparing the estimated airtime usage determined at operation 51 with a predefined threshold value. In this embodiment, when the estimated airtime usage meets or exceeds the predefined threshold value, access point 20 is determined to be saturated. For example, for a predefined saturation threshold of 0.95, access point 20 with an estimated airtime usage at or above this threshold value (e.g., >=0.95) is considered to be saturated. If access point 20 is not determined to be saturated, the method 50 continues estimating airtime usage until saturation is detected. Access point 20 saturation may indicate that client devices 30 are not in compliance with ATF quotas or that reconfiguration of unaccounted-for data for client devices 30 is needed to maintain airtime fairness. Recalculation of new maximum amounts of unaccounted-for data for one or more client devices 30 may force compliance with these ATF quotas and provide general airtime fairness between client devices 30 and access point 20.

As noted above, method 50 may also commence with operation 51. Operation 51 detects receipt of an ATF quota override. The ATF quota override indicates access point 20's intention to recalculate new maximum amounts of unaccounted-for data to meet ATF quotas irrespective of airtime usage and saturation of access point 20. The ATF quota override may be initiated by access point 20, another component in system 1, or a network/system administrator.

Upon determining that access point 20 is saturated or detecting receipt of an ATF quota override, method 50 moves to operation 54 to begin determining characteristics and values that may be used for calculating a new maximum amount of unaccounted-for data for one or more clients 30. The calculation of new maximum amounts of unaccounted-for data may be based on (1) characteristics of data received by access point 20, (2) a total number of client devices 30 associated with access point 20, and/or (3) characteristics of one or more resources available at access point 20 to one or more client devices 30 associated with access point 20. Each of these characteristics and values are described below.

Characteristics of Data Received by Access Point

As noted above, method 50 may use characteristics of data received by access point 20 from one or more client devices 30 to determine the maximum amount of unaccounted-for data for one or more client devices 30. In one embodiment, the characteristics may include an average amount of data received over a period of time by access point 20 from one or more client devices 30. For example, access point 20 may record a listing of data received from each client device 30 over a five second period of time. The amount of data may be represented as bits, bytes, megabytes, or another unit of measurement. Client devices 30 per VAP and TID with higher amounts of data received by access point 20, receive smaller maximum amounts of unaccounted-for data. Conversely, client devices 30 per VAP and TID with lower amounts of data received by access point 20, receive larger maximum amounts of unaccounted-for data. Driving the maximum amounts of unaccounted-for data in this fashion assists in meeting ATF quotas.

In one embodiment, the characteristics of data received by access point 20 include physical layer transmission rates used by one or more client devices 30 to transmit data to access point 20. In one embodiment, access point 20 may determine physical layer transmission rates by, possibly but not limited to, determining a highest rate at which data was received from one or more client devices 30 within a particular period of time. For example, access point 20 may record physical layer transmission rates from each client device 30 over a five second period of time with a highest transmission rate over that span of time denoted. Client devices 30 per VAP and TID with higher transmission rates, receive larger maximum amounts of unaccounted-for data. Conversely, client devices 30 per VAP and TID with lower transmission rates, receive smaller maximum amounts of unaccounted-for data. Driving the maximum amounts of unaccounted-for data in this fashion assists in meeting ATF quotas.

In one embodiment, the characteristics of data received by access point 20 include a data type (e.g., TID) associated with data received from one or more client devices 30. The data types may indicate that a particular client device 30 primarily transmits voice data, video data, BE data, or BK data to access point 20. Based on the determined data types, maximum amounts of unaccounted-for data may be calculated for client devices 30 and VAP based on a priority of data types. In one embodiment, voice data is priority 1, video data is priority 2, BE data is priority 3, and BK data is priority 4. For example, access point 20 may record and classify data received over a designated time period from one or more client devices 30 and VAPs. Based on this recordation, access point 20 may determine that client device 30₁ transmits video data 75% of the time and voice data 25% of the time while client device 30₂ transmits BE data 10% of the time and BK data 90% of the time. In this example, client device 30₁ will receive a larger maximum amount of unaccounted-for data in comparison to client device 30₂, because the data types transmitted by client device 30₁ have higher priority than the data types transmitted by client device 30₂. In one embodiment, calculating the maximum amount of unaccounted-for data (e.g., window size) could be based on a prioritized token bucket mechanism, which will be described by way of example below. Driving the maximum amounts of unaccounted-for data in this fashion assists in meeting ATF quotas.

In one embodiment, the characteristics of data received by access point 20 include an average packet size received by access node 20 from one or more client devices 30. The average packet size may indicate a running or weighted average over a designated time period. For example, access point 20 may determine that on average client device 30₁ transmits one kilobyte packets to access point 20 over a five second time period. This average packet size is associated with client node 30₁. Client devices 30 per VAP and TID with larger average packet sizes receive smaller maximum amounts of unaccounted-for data in comparison to client devices per VAP and TID with smaller average packet sizes. Driving the maximum amounts of unaccounted-for data in this fashion assists in meeting ATF quotas.

In one embodiment, the characteristics of data received by access point 20 include a total amount of airtime used by one or more client devices 30 per TID. The total amount of airtime may be compared against corresponding TxOp quotas. Based on these comparisons, the maximum amounts of unaccounted-for data for each client device 30 and TID are adjusted to meet these TxOp quotas. In another embodiment, total airtime usage by client devices 30 per VAP are also measured and compared against similar quota values. These quota values may represent ATF quotas, which are used to promote airtime fairness between client devices 30 accessing access point 20 for uplink communications.

Total Number of Client Devices Associated with Access Point

As noted above, method 50 may use the total number of client devices 30 associated with access point 20 to determine the maximum amount of unaccounted-for data for client devices 30 per VAP and TID. In one embodiment, operation 54 determines the total number of client devices 30 associated with access point 20. Association with access point 20 may be defined as a direct or an indirect wireless connection between client devices 30 and access point 20. In one example, access point 20 may calculate a total number of client devices 30 associated with access point 20 by adding the total number of client devices 30 associated with each radio or VAP for access point 20. As the total number of client devices 30 associated with access point 20 increases, the maximum amounts of unaccounted-for data per client device 30 increases. Driving the maximum amounts of unaccounted-for data in this fashion assists in meeting ATF quotas.

Characteristics of One or More Resources Available at an Access Point to One or More Client Devices

As noted above, method 50 may use characteristics of one or more resources available at access point 20 to one or more client devices 30 to determine the maximum amount of unaccounted-for data. In one embodiment, operation 54 determines characteristics of one or more resources available at access point 20 to one or more client devices 30. The characteristics may include determining one or more of available memory on access point 20 (including available or total buffers on access point 20), available processing power provided by hardware processor 21, and cache limitations on access point 20. As access point 20 resources available to client devices 30 increase, the maximum amounts of unaccounted-for data per client device 30 increases. Conversely, as access point 20 resources available to client devices 30 decrease, the maximum amounts of unaccounted-for data per client device 30 decreases. Driving the maximum amounts of unaccounted-for data in this fashion assists in meeting ATF quotas.

Based on one or more of the above described characteristics and values determined at operation 54, operation 55 determines a maximum amount of unaccounted-for data to be transmitted by one or more client devices 30. In one embodiment, the maximum amount of unaccounted-for data is determined based on the relationships/constraints described above for corresponding characteristics and values such that ATF quotas may be reached. For example, the ATF quotas may designate 40% airtime usage allocated to VAP₁ and 60% airtime usage allocated to VAP₂. Operation 55 determines the smallest maximum amounts of unaccounted-for data for each client device 30 and/or TID to achieve these ATF quotas.

Following the determination of maximum amounts of unaccounted-for data for each client device 30, the maximum amounts of unaccounted-for data are transmitted to each corresponding client device 30 at operation 56. In one embodiment, the amounts are only transmitted to client devices 30 whose maximum amount value have changed. Upon receipt, the maximum amounts of unaccounted-for data are used by each of client devices 30 to transmit data to access point 20.

Based on the transmissions of data to access point 20 using the determined maximum amounts of unaccounted-for data, operations 58-64 check for over and under corrections that may have occurred during the previous operations. Operations 58-64 may be repeatedly performed to ensure the maximum amounts of unaccounted-for data for each client device 30 are adjusted to be accurate.

For example a counter may be set to zero or another initiating value. The counter may be used to keep track of the number of iterations through the correction check. The correction check is performed a predefined number of times to ensure an accurate maximum amount of unaccounted-for data is calculated for each client device 30. The predefined number of iterations through the correction check may be set by a network/system administrator. In one embodiment, the predefined number of iterations is equal to ten.

At operation 58 airtime usage for access point 20 is estimated. In one embodiment, the estimated airtime usage is calculated by measuring the total airtime usage across all VAPs for access point 20. For example, for access point 20 with VAP₁ and VAP₂, the estimated airtime usage is the sum of the individual airtime usages of VAP₁ and VAP₂. In one embodiment, the estimated airtime usage for access point 20 is calculated over a discrete time period to determine an average estimated airtime for access point 20.

At operation 59, the estimated airtime usage calculated at operation 58 is compared against upper and lower limits. The upper and lower limits may be predefined by a network/system administrator or a device in system 1. For example, a network/system administrator may preset the upper limit to be equal to 0.90 and the lower limit to be equal to 0.60. If the estimated airtime usage falls between these limits, no correction to the maximum amounts of unaccounted-for data needs to be performed and method 50 transitions to operation 63.

If the estimated airtime usage is above the upper limit or below the lower limit, the maximum amounts of unaccounted-for data for one or more of client devices 30 are scaled down or up at operations 60 and 61, respectively. For example, if the estimated airtime usage is above the upper limit, each of the maximum amounts of unaccounted-for data for each client device 30 may be scaled down 10%. In another example, if the estimated airtime usage is below the lower limit, each of the maximum amounts of unaccounted-for data for each client device 30 may be scaled up 10%. The degree of scaling may be preset and fixed or variable based on a table or equation. For example, an equation for scaling the maximum amount of unaccounted-for data could include determining the amount by which a certain client device 30 exceeds its quota and using that value (e.g., a percentage) to scale the maximum amount of unaccounted-for data. Scaling the maximum amounts of unaccounted-for data corrects for over and under corrections that may result by altering multiple maximum amounts of unaccounted-for data for multiple client devise 30 at the same time.

Following scaling procedures at operations 60 and 61, operation 62 transmits the maximum amounts of unaccounted-for data to each corresponding client device 30. In one embodiment, the amounts are only transmitted to client devices 30 whose maximum amount values have changed. Upon receipt, the maximum amounts of unaccounted-for data are used by each of client device 30 to transmit data to access point 20.

In one embodiment, following scaling operations 60 and 61, the counter may be incremented to indicate a successful run through the overcorrection check operations. The counter may thereafter be compared with the predefined number of iterations value. If the counter is not equal to the predefined number of iterations, the correction check continues by returning to operation 58. Otherwise, if the counter is equal to the predefined number of iterations value, the correction check terminates and method 50 moves to a starting position.

By adjusting maximum amounts of unaccounted-for data for client devices 30, access point 20 may enforce airtime limits irrespective of the rates and packet sizes used by each client device 30.

Example Implementations

Example situations for determining maximum amounts of unaccounted-for data for client devices 30 per VAP and TID using the system and methods described above will now be described.

Problem Formulation

In the following problem scenario, the following are known:
a. Maximum amounts of unaccounted-for data (e.g., window size) negotiated by every client device 30ᵢ for a TID t, associated with a VAPₖ may be denoted by W_{k,i,t};
b. Max allowable airtime per TID t per client device 30 may be determined by TxOp_{k,t} for that VAPₖ;
c. Max allowable total airtime quota per VAPₖ may be given as Qₖ;
d. Max allowable total airtime quota per AC t per VAPₖ may be given as AC_{k,t};
e. Airtime used by a client device 30ᵢ per TID t may be denoted as U_{k,i,t};
f. Airtime used by each of client devices 30 may be denoted by u_{k,i}; and
g. Total uplink airtime allocated to the VAPₖ may be given by Aₖ.

To solve the problem W_{k,i,t} values must be determined (e.g., maximum amounts of unaccounted-for data per client, VAP, and TID) such that the following constraints are met:
a. TxOp enforcement such that airtime for each TID t in each VAP k complies with the equation (U_{k,i,t})<=TxOp_{k,t}. This equation limits the airtime used by every client device's 30 TIDs to a particular TxOp described by the system administrator.
b. Airtime quota enforcement such that AC airtime quota per VAP complies with the equation (Σ_{i=1 to M} (U_{k,i,t}))<=AC_{k,t}. This equation indicates that for all client devices 30ᵢ associated with a particular VAP k, the sum of airtime used for a TID t over all client devices 30 within that VAP should be less than the allocated quota of AC_{k,t}.
c. Airtime quota enforcement per VAP such that for each VAP k airtime complies with the equation (Σ_{i=1 to M} Σ_{t=1 to T} (U_{k,i,t}))<=Qₖ. This equation sums over all the associated client devices 30ᵢ and all TIDs t for a particular VAP k, and ensures that this total time is less than the allocated quota Qₖ.
d. Per client device 30ᵢ uplink airtime fairness enforcement such that airtime complies with the equation

$${\sum }_{t = 1 to T}^{ } {U}_{k , i , t} \leq \frac{{Q}_{k} + Unused ( {U}_{i} )}{M} .$$

in this equation,

$$\frac{{Q}_{k}}{M}$$

denotes the total airtime quota for the VAP k divided into M parts for each of client devices 30ᵢ. Further, Unused(Uᵢ) denotes the unused airtime for all client devices 30ᵢ associated with that VAP. The left hand side of the equation sums over all the TIDs originating from a single client device 30ᵢ and ensures that the total airtime used by the client device 30ᵢ is less than or equal to its airtime quota and unused airtime divided across all M client devices.

The above constraints each fall into one or more of the characteristics and values discussed above in relation to method 50. By computing maximum amounts of unaccounted-for data for client devices 30 based on these constraints, airtime fairness may be enforced without modification to client devices 30. In one embodiment, while deploying the above described airtime fairness mechanism a network/system administrator may want to impose all or any subset of the above constraints for airtime fairness. By applying these constraints with TID fairness, WMM fairness control is also achieved.

Apart from the above constraints which rely on airtime computation, in one embodiment constraints may be imposed that limit the maximum amounts of unaccounted-for data (e.g., window size) on other constraints such as available memory, processor capacity, and cache limitations relative to access point 20 and each VAP. For example, receive-buffers can be shared fairly across associated client devices 30. For instance, the total number of receive-buffers available for a VAP may be denoted by the variable rxb. These rxb buffers may be shared across all the associated client devices 30 with that VAP by using a token bucket mechanism. Using this mechanism, each of the rxbs will denote a token in the token bucket system. For M associated client devices 30, each client device 30 may have a maximum of

$$\frac{rxb}{M}$$

buffers when rxbs are limited. Client devices 30 that do not use all of their

$$\frac{rxb}{M}$$

allocated buffers may have their unused buffers (i.e., tokens) recycled in a common pool. Hence, each client device 30 may now use

$$\frac{rxb}{M} + \frac{Common Pool}{Number of Active Client}$$

buffers. In this equation, the number of active clients denotes the number of client devices 30 with active maximum amounts of unaccounted-for data (e.g., window size) negotiations with access point 20. In the absence of VAPs or VAP rxb quotas, the same mechanism may work across a single radio. Although described in relation to a token bucket mechanism, in some embodiments other mechanisms and techniques may be used to share resources across VAPs, including bin-packing and/or machine learning techniques.

This approach for rx-buffer allocation may be extended to limit memory resources used for allocating Pc-buffers. Thus, the maximum amounts of unaccounted-for data will be the minimum of that determined by the airtime constraints in equations a-d listed above and the number of available residual system resources as determined by the token bucket mechanism.

Quota Determination Algorithm

Quota determination deals with airtime quota calculation based on the expected benefit (Revenue or Rev) that can be achieved from provisioning. In one embodiment, the unaccounted-for data sizes are based on the quotas calculated using this formulation. Quota determination is optional and may be replaced by system configured quota values instead.

Solving for airtime quotas (e.g., ATF quotas) is formulated as a linear program that can be solved efficiently by access point 20. For example, a revenue function Rev(Uₜ) may be used that is linearly or convexly proportional to the TID for which uplink airtime is allocated. An example of a set of revenue functions could be the per VAP per TID returns. For instance, one VAP may value voice data traffic over BE data traffic while another VAP or radio may not share these priorities. The revenue function Rev(Uₜ) may be setup to reflect this requirement. In one embodiment, these revenue functions may be maximized so that the product will automatically result in maximization of the airtime for high priority classes.

A linear optimization formulation of the problem may be as follows:

$$Maximize \text{:} {\sum }_{k = 1 to V}^{ } {\sum }_{i = 1 to M}^{ } {\sum }_{t = 1 to T}^{ } Rev ( {U}_{k , i , t} )$$

$$\begin{matrix}Subject to \text{:} & ( {U}_{k , i , t} ) <= {TXOP}_{k , t} \\ & ( {\sum }_{i = 1 to M}^{ } ( {U}_{k , i , t} ) ) <= {AC}_{k , t} \\ & ( {\sum }_{i = 1 to M}^{ } {\sum }_{t = 1 to T}^{ } ( {U}_{k , i , t} ) ) <= {Q}_{k} \\ & ( {\sum }_{t = 1 to T}^{ } ( {U}_{k , i , t} ) ) <= ( \frac{1}{M} ) * {Q}_{k}\end{matrix}$$

The used airtime U may be translated into calculated airtime by using the per TID per client device 30 rate and packet size information available at access point 20. Additional constraints may be solved with this optimization formulation to ensure high/efficient performance. For example, load based constraints that ensure a certain percentage of airtime was used by TIDs in past cycles may be used. Further, rate based constraints may be used. For instance, for bad client detection, additional constraints on the minimum rate used by client devices 30 for a particular TID may be used.

Quota Enforcement

Once airtime quotas have been determined using the example provided above or other suitable methods, these values may be enforced by converting them to appropriate maximum amounts of unaccounted-for data (e.g., window sizes) using the below described technique. This technique is an example embodiment of method 50 shown in FIG. 4.

To enforce quotas, the following information may be determined for use by access point 20:
a. Average packet size per TID t and per client device 30ᵢ, which may be denoted as P_{i,t}. This average could be a running average or an exponential weighted average to account for changes in recent rate selection by client devices 30 for a TID. In one embodiment, this decision can be based on an expected mobility pattern in the deployment. If client devices 30 are pseudo-stationary a simple average should suffice while in other situations an exponential weighted average may be used.
b. Average/last known rate per TID t and per client device 30ᵢ, which may be denoted as R_{i,t}. Rate information may be extracted from a rate table in a driver of client device 30ᵢ.

In one embodiment, a two-step heuristic approach is used for enforcing quotas: (1) calculate the maximum amounts of unaccounted-for data (e.g., window sizes) for client devices 30 and (2) use statistics accumulated from repeated cycles for correcting estimates for the maximum amounts of unaccounted-for data.

Step 1—Baseline Maximum Amount of Unaccounted-for Data Calculation

Depending on which of the four constraints from equations a-d need to be enforced, the permitted maximum amount of unaccounted-for data per client device 30 per TID is calculated as the smallest value which satisfies those constraints. For example, using all four constraints, it is first determined if access point 20 is operating at saturation by measuring the total fractions of airtime across all VAPs (e.g., (Σ_{k=1 to v} Σ_{i=1 to M} Σ_{t=1 to T} (U_{k,i,t}))) and comparing this total value with a threshold β. The threshold β could be a predefined value set by a network/system administrator. For example, if the threshold β is equal to 0.95, maximum amount of unaccounted-for data calculations would commence when total airtime is greater than 95%. Although in some embodiments, limiting of the number of uplink frames by enforcing maximum amounts of unaccounted-for data is performed only in the presence of access point 20 saturation, in other embodiments an override may be used to start the enforcement process.

If saturation is detected, each maximum amount of unaccounted-for data is calculated per equations a-d. For example to impose the TxOp constraint discussed in equation a, the maximum amount of unaccounted-for data may be calculated for each client device 30 as:

$${W}_{k , i , t} = \frac{{TxOp}_{k , t} \times average transmission rate}{average packet size}$$

Once the unacknowledged data size W_{k,i,t} estimates are determined for all client devices 30, a check may be performed to determine if the W_{k,i,t} values (i.e., maximum amount of unaccounted-for data) violate any of the constraints in equations a-d. If any of the constraints are violated, the W_{k,i,t} values may be scaled to remove violations. Scaling may be performed on low priority flows/TIDs first before higher priority flows/TIDs. Once these W_{k,i,t} estimates are obtained, the second step of the algorithm for correction in window sizes is performed.

In one embodiment, step 1 described above may be implemented by operations 51-56 shown in FIG. 4.

Step 2—Correction Based on Past Observations

This step of the algorithm is required for checking over and under corrections that could have happened in the previous step. Over corrections can happen all or several maximum amounts of unaccounted-for data are modified at the same time. This simultaneous change could cause a drastic decrease in the estimated airtime usage in the next cycle based on previous per TID per STA rate and packet size estimates. Under-corrections can happen if historic rates and average packet sizes for setting window estimates are used. However, this may still result in over-utilization of allocated airtime by a TID and/or client device 30.

In case of over corrections, all maximum amounts of unaccounted-for data are scaled up appropriately to ensure that the medium is correctly used. In case of under-correction, maximum amounts of unaccounted-for data for the clients where under-correction has been flagged in the past cycles are scaled down. Over corrections and under corrections are based on some preset thresholds. Once scaling is done one or more times and the maximum amounts of unaccounted-for data are reset for all client devices 30 and TIDs, step 1 of the algorithm may be again performed.

In one embodiment, step 2 described above may be implemented by operations 58-62 shown in FIG. 4.

By calculating the maximum amount of unaccounted-for data based on the methods and systems described above, client devices 30 are forced to adhere to airtime fairness quotas without requiring modifications to the client devices. For example, the above systems and methods may alleviate non-uniformity in client devices 30 (e.g., client devices 30 that have non-uniform aggregation depth and client devices 30 take undue advantage of better TxOp values for voice/video classes by setting all data traffic to use those TxOps) by calculating maximum amounts of unaccounted-for data that enforce airtime fairness policies.

An embodiment of the invention may be an article of manufacture in which a machine-readable medium (such as microelectronic memory) has stored thereon instructions which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components. Also, although the discussion focuses on uplink medium control with respect to frame aggregation, it is contemplated that control of other types of messages are applicable.

Any combination of the above features and functionalities may used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
determining one or more characteristics associated with data received by an access point from one or more client devices associated with the access point, the access point comprising a hardware processor;
determining a maximum amount of unaccounted-for data to be transmitted by a particular client device of the one or more client devices based on the one or more characteristics; and
transmitting, by the access point, the maximum amount of unaccounted-for data to the particular client device.

2. The method of claim 1, further comprising:
detecting changes to the one or more characteristics;
dynamically modifying the maximum amount of unaccounted-for data for the particular client device based on the detected changes to the one or more characteristics; and
transmitting, by the access point, the modified maximum amount of unaccounted-for data for the particular client device to the particular client device.

3. The method of claim 1, wherein determining the one or more characteristics comprises:
determining an average amount of data received over a period of time by the access point from the particular client device.

4. The method of claim 1, wherein determining the one or more characteristics comprises:
determining a physical layer transmission rate used by the particular client device to transmit the data to the access point.

5. The method of claim 4, wherein determining the physical layer transmission rate comprises:
determining a highest rate at which data was received from the particular client device within a particular period of time.

6. The method of claim 1, wherein determining the one or more characteristics comprises:
determining a data type associated with data received from the particular client device.

7. The method of claim 1, wherein determining the one or more characteristics comprises:
determining an average packet size from data packets received from the particular client device.

8. The method of claim 1, wherein determining the one or more characteristics comprises:
determining a total amount of airtime used by the particular client device per data class type.

9. The method of claim 1, wherein the operation of determining the maximum amount of unaccounted-for data based on the one or more characteristics is performed in response to detecting that an estimated airtime usage for one or more radios used by the access point is above a predefined level.

10. The method of claim 1, wherein the maximum amount of unaccounted-for data determined for the particular client device is different than a maximum amount of unaccounted-for data determined for a second client device of the one or more client devices.

11. The method of claim 1, further comprising:
estimating airtime usage for a second client device associated with the access point based on a second maximum amount of unaccounted-for data for the second client device;
increasing the second maximum amount of unaccounted-for data for the second client device if the estimated airtime usage is above a predefined upper limit; and
decreasing the second maximum amount of unaccounted-for data for the second client device if the estimated airtime usage is below the predefined lower limit.

12. The method of claim 1, wherein the unaccounted-for data comprises (a) data transmitted by the particular client device to the access point for which the particular client device has not received an acknowledgement from the access point and (b) data transmitted by the particular client device to the access point that has not been determined by the particular client device to be dropped data.

13. The method of claim 1, wherein the maximum amount of unaccounted-for data comprises a maximum number of unaccounted-for frames for a Medium Access Control (MAC) Protocol Data Unit (MPDU) at a MAC layer.

14. The method of claim 1, wherein the maximum amount of unaccounted-for data comprises a total amount of unaccounted-for data transmitted by the particular client device.

15. The method of claim 1, wherein the maximum amount of unaccounted-for data comprises a maximum number of unaccounted-for frames the particular client device is permitted to transmit to the access point without stopping transmission to allow other client devices to sense and transmit on a radio of the access point during a particular time period.

16. The method of claim 1, wherein the maximum amount of unaccounted-for data comprises a maximum number of unaccounted-for frames that can be sent by the particular client device to devices within a same IP subnet as the particular client device.

17. A method comprising:
determining a total number of client devices associated with a digital device, the digital device comprising a hardware processor;
determining a maximum amount of unaccounted-for data to be transmitted by a particular client device of the one or more client devices based on the total number of client devices associated with the digital device; and
transmitting, by the digital device, the maximum amount of unaccounted-for data to the particular client device.

18. The method of claim 17, wherein the digital device is an access point.

19. The method of claim 18, further comprising:
detecting changes to the total number of client devices associated with the access point;
dynamically modifying the maximum amount of unaccounted-for data for the particular client device based on the detected changes to the total number of client devices associated with the access point; and
transmitting, by the access point, the modified maximum amount of unaccounted-for data to the particular client device.

20. The method of claim 18, wherein the operation of determining the maximum amount of unaccounted-for data based on the total number of client devices associated with the access point is performed in response to detecting that an estimated airtime usage for one or more radios used by the access point is above a predefined level.

21. The method of claim 18, wherein the maximum amount of unaccounted-for data determined for the particular client device is different than a maximum amount of unaccounted-for data determined for a second client device of the one or more client devices.

22. The method of claim 18, further comprising:
estimating airtime usage for a second client device associated with the access point based on a second maximum amount of unaccounted-for data for the second client device;
increasing the second maximum amount of unaccounted-for data for the second client device if the estimated airtime usage is above a predefined upper limit; and
decreasing the second maximum amount of unaccounted-for data for the second client device if the estimated airtime usage is below the predefined lower limit.

23. The method of claim 18, wherein the unaccounted-for data comprises (a) data transmitted by the particular client device to the access point for which the particular client device has not received an acknowledgement from the access point and (b) data transmitted by the particular client device to the access point that has not been determined by the particular client device to be dropped data.

24. The method of claim 18, wherein the maximum amount of unaccounted-for data comprises a maximum number of unaccounted-for frames for a Medium Access Control (MAC) Protocol Data Unit (MPDU) at a MAC layer.

25. The method of claim 18, wherein the maximum amount of unaccounted-for data comprises a total amount of unaccounted-for data transmitted by the particular client device.

26. The method of claim 18, wherein the maximum amount of unaccounted-for data comprises a maximum number of unaccounted-for frames the particular client device is permitted to transmit to the access point without stopping transmission to allow other client devices to sense and transmit on a radio of the access point during a particular time period.

27. The method of claim 18, wherein the maximum amount of unaccounted-for data comprises a maximum number of unaccounted-for frames that can be sent by the particular client device to devices within a same IP subnet as the particular client device.

28. A method comprising:
determining characteristics of one or more resources available at an access point comprising a hardware processor;
determining a maximum amount of unaccounted-for data, to be transmitted by a particular client device of one or more client devices associated with the access point, based on the characteristics of the one or more resources; and
transmitting, by the access point, the maximum amount of unaccounted-for data to the particular client device.

29. The method of claim 28, wherein determining characteristics of one or more resources available at the access point comprises:
determining available memory on the access point.

30. The method of claim 28, wherein determining characteristics of one or more resources available at the access point comprises:
determining available processing power provided by the hardware processor.

31. The method of claim 28, wherein determining characteristics of one or more resources available at the access point comprises:
determining cache limitations on the access point.

32. The method of claim 28, further comprising:
detecting changes to the characteristics of the one or more resources available at the access point to the one or more client devices;
dynamically modifying the maximum amount of unaccounted-for data for the particular client device based on the detected changes to the characteristics; and
transmitting, by the access point, the modified maximum amount of unaccounted-for data to the particular client device.

33. The method of claim 28, wherein the operation of determining the maximum amount of unaccounted-for data based on the characteristics of the one or more resources available at the access point to the one or more client devices is performed in response to detecting that an estimated airtime usage for one or more radios used by the access point is above a predefined level.

34. The method of claim 28, wherein the maximum amount of unaccounted-for data determined for the particular client device is different than a maximum amount of unaccounted-for data determined for a second client device of the one or more client devices.

35. The method of claim 28, further comprising:
estimating airtime usage for a second client device associated with the access point based on a second maximum amount of unaccounted-for data for the second client device;
increasing the second maximum amount of unaccounted-for data for the second client device if the estimated airtime usage is above a predefined upper limit; and
decreasing the second maximum amount of unaccounted-for data for the second client device if the estimated airtime usage is below the predefined lower limit.

36. The method of claim 28, wherein the unaccounted-for data comprises (a) data transmitted by the particular client device to the access point for which the particular client device has not received an acknowledgement from the access point and (b) data transmitted by the particular client device to the access point that has not been determined by the particular client device to be dropped data.

37. The method of claim 28, wherein the maximum amount of unaccounted-for data comprises a maximum number of unaccounted-for frames for a Medium Access Control (MAC) Protocol Data Unit (MPDU) at a MAC layer.

38. The method of claim 28, wherein the maximum amount of unaccounted-for data comprises a total amount of unaccounted-for data transmitted by the particular client device.

39. The method of claim 28, wherein the maximum amount of unaccounted-for data comprises a maximum number of unaccounted-for frames the particular client device is permitted to transmit to the access point without stopping transmission to allow other client devices to sense and transmit on a radio of the access point during a particular time period when the particular client device has control of a radio of the access point.

40. The method of claim 28, wherein the maximum amount of unaccounted-for data comprises a maximum number of unaccounted-for frames that can be sent by the particular client device to devices within a same IP subnet as the particular client device.
